(19) United States
(12) Patent Application Publication
(10) Pub. No.: US 2026/0145471 A1
(43) Pub. Date: May 28, 2026

(54) Noah McKinley Pickett Extended Trailer Hitch

(71) Applicant: Noah McKinley Pickett, Schertz, TX (US)

(72) Inventor: Noah McKinley Pickett, Schertz, TX (US)

(21) Appl. No.: 19/390,487

(22) Filed: Nov. 15, 2025

Related U.S. Application Data
(60) Provisional application No. 63/702,653, filed on Nov. 25, 2024.

(51) Int. Cl. B60D 1/145; B60D 1/04; B60D 1/14; B60D 1/46

(52) U.S. Cl. CPC B60D 1/145; B60D 1/04; B60D 1/143; B60D 1/46

(57) ABSTRACT

A towing clearance extension assembly is provided for use between a towing vehicle and a trailer. The assembly includes an elongated main arm with a vehicle-mounting interface at a first end and a trailer-mounting interface at a second end, and at least one reinforcement gusset extending between the main arm and the trailer-mounting interface. The main arm has a length greater than a standard hitch supplied with the trailer to provide increased clearance between the towing vehicle and the trailer and to reduce the risk of contact between them during sharp turns. In some embodiments, the length is sufficient to allow the trailer to be pivoted to ninety degrees relative to a longitudinal axis of the towing vehicle while maintaining clearance between a forward region of the trailer and a rear region of the towing vehicle, thereby permitting rear doors or tailgates to be opened while the trailer remains attached.

### CROSS-REFERENCE TO RELATED APPLICATIONS

This application claims the benefit of U.S. Provisional Patent Application No. 63/702,653, filed Nov. 25, 2024, titled “Noah McKinley Pickett Extended Trailer Hitch for M1101 and M1102 Military Trailers,” the entire contents of which are incorporated by reference herein.

### FIELD OF THE INVENTION

The present invention relates generally to towing systems, and more particularly to towing extension assemblies configured to provide increased clearance between a towing vehicle and a trailer.

### BACKGROUND OF THE INVENTION

The M1101 and M1102 military trailers are widely used for heavy-load transportation across different terrains. The standard hitches that come with these trailers may not provide adequate length, strength, or versatility. Conventional towing arrangements for military and civilian trailers, including High Mobility Multipurpose Wheeled Vehicle (HMMWV) trailers such as M1101 and M1102 trailers, often position the trailer very close to the rear of the towing vehicle. This limited clearance restricts the pivot angle between the trailer and the towing vehicle and can prevent rear doors, tailgates, or ambulance doors on the towing vehicle from being fully opened while the trailer is attached.

Existing hitch extenders and drawbars may increase the distance between the towing vehicle and trailer, but are typically not dimensioned or configured to allow heavy military trailers to pivot to approximately a ninety-degree angle relative to the towing vehicle while maintaining adequate clearance for full rear access. In addition, many existing solutions are not optimized for off-road conditions or for vehicles with tall, flat rear surfaces such as HMMWV-based ambulances.

There is therefore a need for a towing clearance extension assembly that permits a trailer—such as a Humvee trailer or other military or civilian trailer—to remain connected while being pivoted to approximately ninety degrees (or more) relative to the towing vehicle without contact between the trailer and the rear of the vehicle, thereby preserving full access to rear doors or cargo areas. There is also a need for such an assembly to be structurally robust for on-road and off-road use, and adaptable to a range of vehicle and trailer combinations.

### SUMMARY OF THE INVENTION

In one embodiment, a towing clearance extension assembly is provided for use between a towing vehicle and a trailer. The assembly includes an elongated main arm having a first end and a second end, a vehicle-mounting interface at the first end configured to be coupled to a rear hitch connection of the towing vehicle, a trailer-mounting interface at the second end configured to be coupled to a forward portion of the trailer, and at least one reinforcement gusset extending between the main arm and the trailer-mounting interface. The elongated main arm has a length greater than a standard hitch supplied with the trailer and is configured to provide increased clearance between the towing vehicle and the trailer and to reduce a risk of contact between the towing vehicle and the trailer during sharp turns.

In certain embodiments, the towing vehicle comprises a HMMWV or HMMWV-based ambulance, and the trailer comprises an M1101 or M1102 military trailer. In some embodiments, the elongated main arm comprises a rectangular steel tube reinforced with gusset plates and a multi-position channel bracket to accommodate various trailer mounting geometries and heights. The assembly may be sized for heavy military trailers, and may also be used with civilian trailers and pickup trucks.

In some embodiments, the length of the main arm is selected such that the increased clearance between the towing vehicle and the trailer allows the trailer to be pivoted to at least about ninety degrees, and in certain embodiments to a jack-knifed position greater than ninety degrees, relative to the longitudinal axis of the towing vehicle without contact between the trailer and the vehicle. This enhanced clearance permits full opening of rear doors, tailgates, or ambulance doors of the towing vehicle while the trailer remains attached.

Additional embodiments may include alternative cross-sections for the elongated main arm, such as round tubing, I-beams, C-channels, or boxed sections, as well as fixed-length and adjustable or telescoping configurations. The towing clearance extension assembly may further incorporate mounts for safety chains, electrical connectors, or air lines, and may include shock-absorbing or articulation elements.

Additional embodiments, features, and advantages will be apparent from the following description and the appended drawings and claims.

### BRIEF DESCRIPTION OF THE DRAWINGS

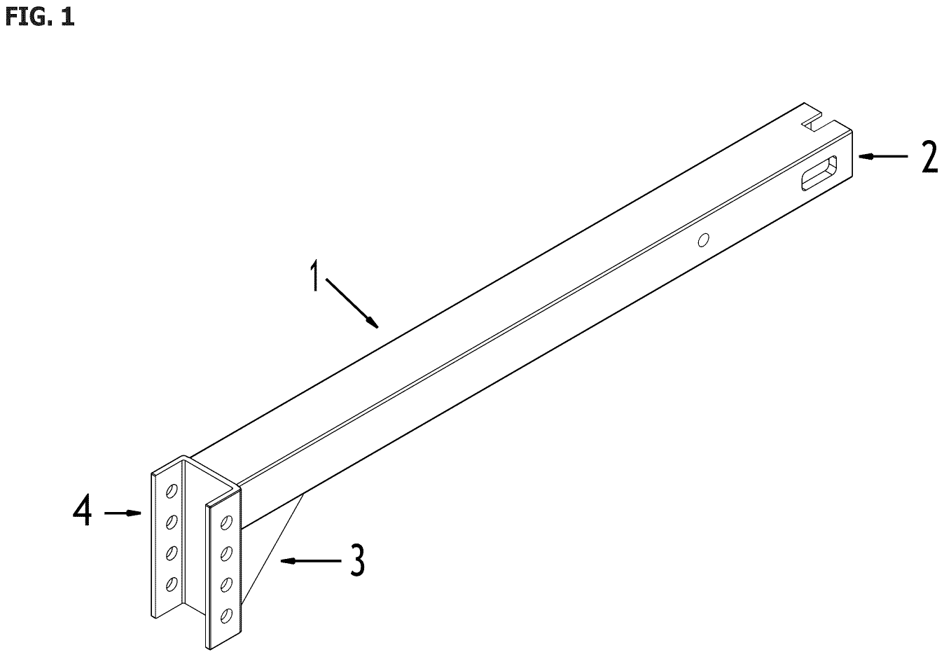

1. FIG. 1 is an orthographic view of towing extension assembly.

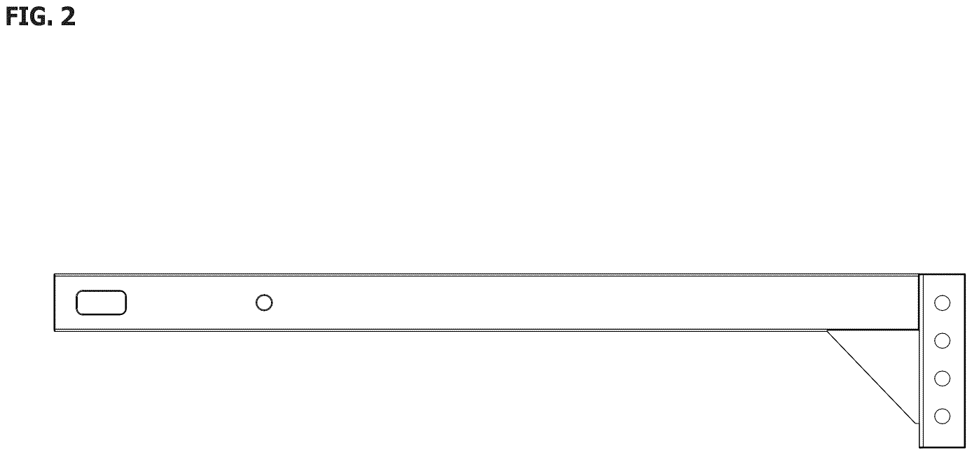

2. FIG. 2 is a side view of towing extension assembly.

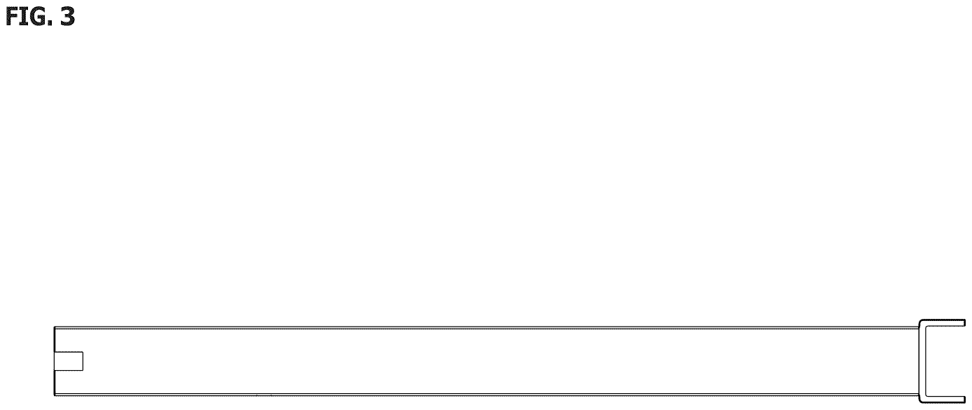

3. FIG. 3 is a top view of towing extension assembly.

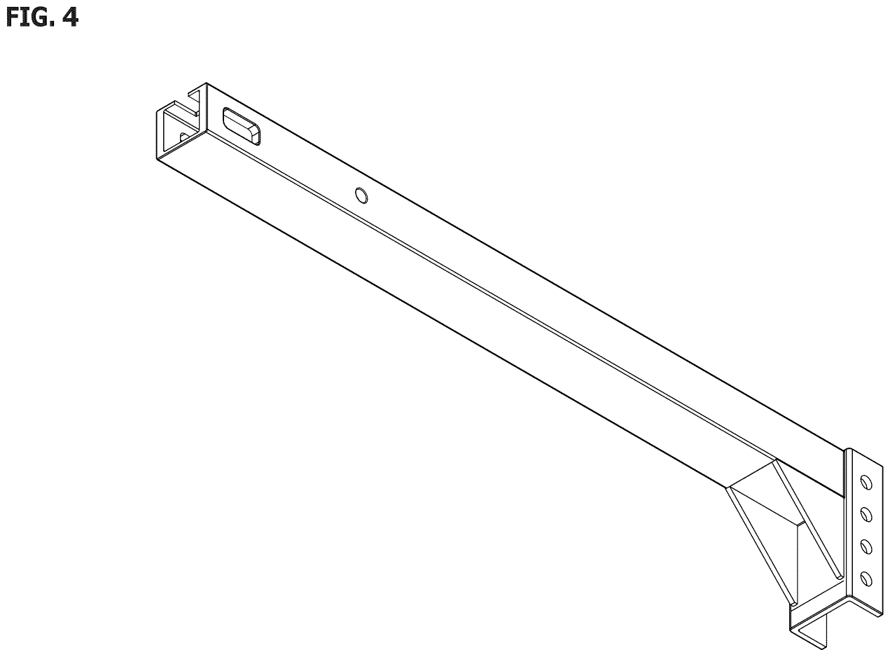

4. FIG. 4 is a bottom view of towing extension.

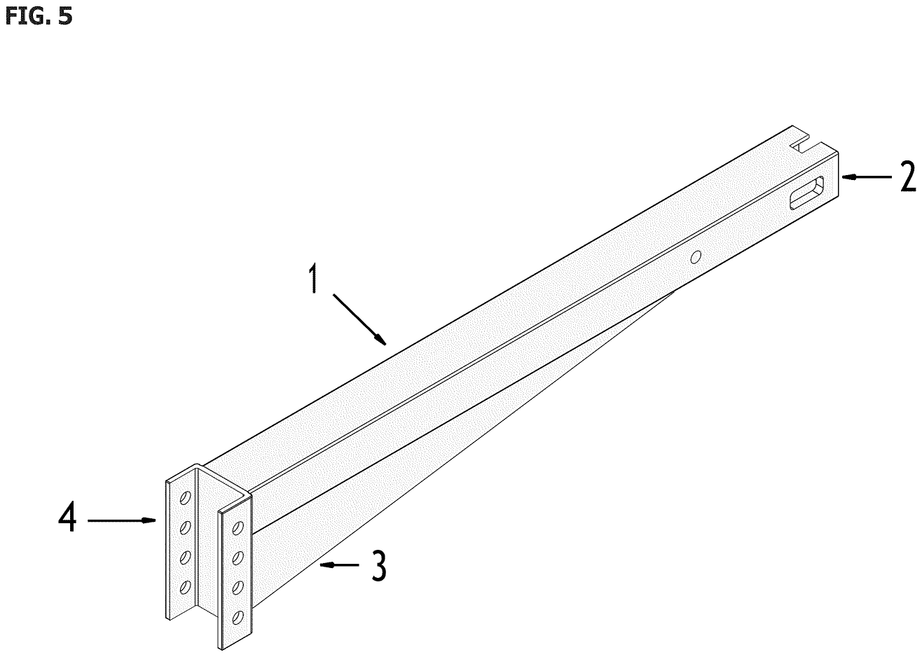

5. FIG. 5 is an orthographic view of an alternative embodiment in which the reinforcement gussets extend along a greater portion of the main arm.

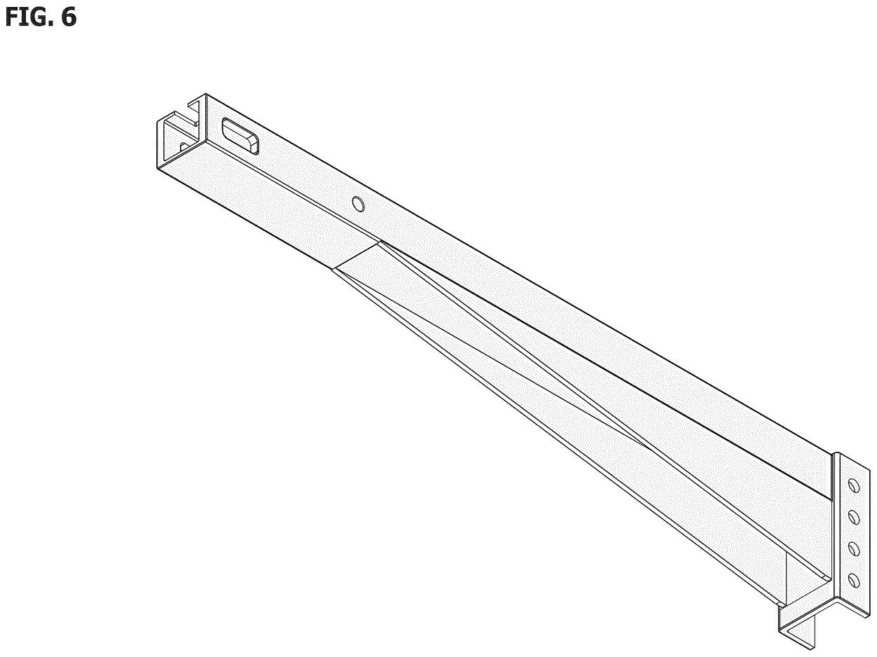

6. FIG. 6 is a bottom view of an alternative embodiment in which the reinforcement gussets extend along a greater portion of the main arm.

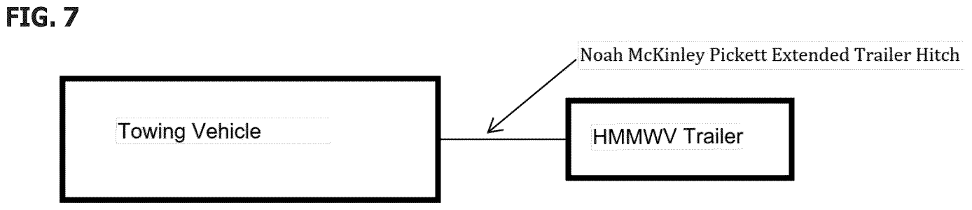

7. FIG. 7 is a top-down plan view of a towing vehicle and trailer in a substantially aligned (0°) towing configuration using the towing clearance extension assembly.

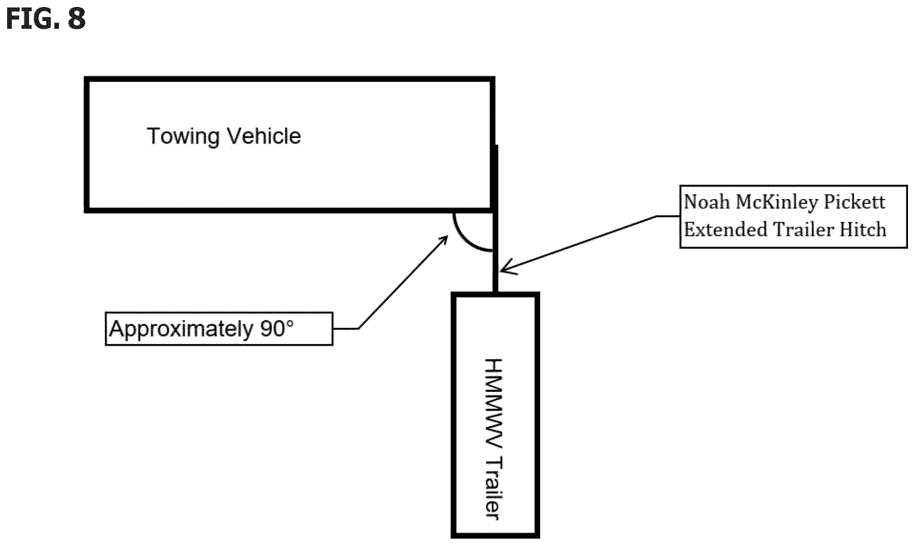

8. FIG. 8 is a top-down plan view of the towing vehicle and trailer in a jack-knifed configuration at approximately ninety degrees using the towing clearance extension assembly, illustrating maintained clearance between the trailer and the rear of the towing vehicle and full access to rear doors.

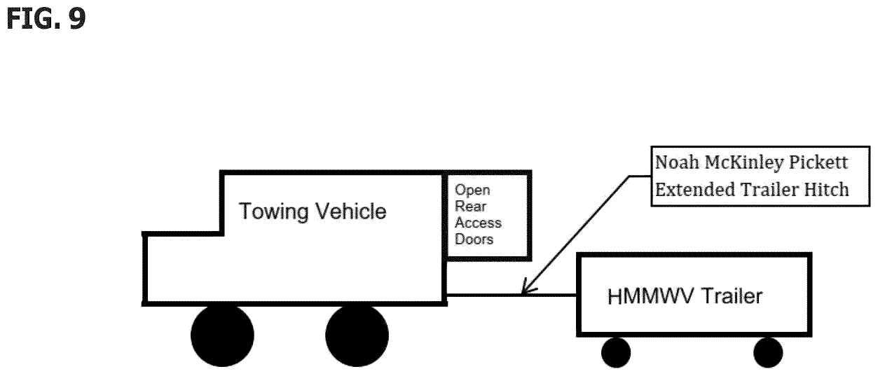

9. FIG. 9 is a side view illustrating a towing vehicle with rear doors open while the trailer remains attached via the towing clearance extension assembly strai

### DETAILED DESCRIPTION OF THE INVENTION

The following detailed description describes example embodiments of a towing clearance extension assembly configured to increase the distance between a towing vehicle and a trailer in order to permit greater pivot angles and improved rear access. While the description references specific military vehicles and trailers, such as HMMWVs and M1101/M1102 trailers, the embodiments are not limited to these particular vehicles or trailers.

In one embodiment, the Noah McKinley Pickett Extended Trailer Hitch is specifically designed for M1101 and M1102 military trailers. The main arm measures approximately 37.56 inches in length, with a width of 3 inches and a height of 2.5 inches. The width side has a metal thickness of approximately 0.1945 inches, while the height side has a metal thickness of approximately 0.45 inches. This robust construction ensures that the hitch can handle significant towing loads with minimal deformation.

A receiver side at a first end of the main arm is designed for plug-and-play integration with M1101 and M1102 trailers. It features pre-drilled holes and sections that match the factory mounting points, providing secure installation without modification. At the opposite end of the main arm, a trailer-mounting interface includes a multi-position channel bracket that provides flexible attachment options for a lunette ring or other towing accessories. The channel bracket has a thickness of approximately 0.2845 inches and may provide three or more vertical mounting positions.

Reinforcement gussets are welded at the joint between the main arm and the channel bracket. In some embodiments, the gussets measure approximately 4 inches by 4 inches and have a thickness of approximately 0.25 inches. These gussets help distribute stress evenly and prevent flex or structural failure under heavy loads. In alternative embodiments, the gussets may be extended along a greater portion of the main arm to increase the reinforced region and further distribute stress, as illustrated in FIG. 6.

The extended length of the main arm increases the distance between the towing vehicle and the trailer compared to standard hitches. This additional clearance enhances maneuverability and reduces the risk of trailer contact with the towing vehicle during sharp turns. In certain embodiments, the length is sufficient to allow the trailer to be pivoted to approximately ninety degrees relative to the longitudinal axis of the towing vehicle, effectively a jack-knifed position, while maintaining clearance between the forward edge of the trailer and the rear of the vehicle. This configuration enables full access to rear doors, tailgates, or ambulance doors of the towing vehicle without decoupling the trailer, which is particularly advantageous in field operations and emergency situations.

The hitch can be modified in length, material thickness, or gusset placement to adapt to different towing applications. These variations allow for tailored solutions based on specific user needs and towing environments. Alternative cross-sections may be used for the main arm, including round tubing, I-beams, C-channels, or boxed sections. The assembly may also be made adjustable or telescoping to accommodate different vehicle and trailer combinations.

The towing clearance extension assembly may integrate mounts for safety chains, electrical connectors, and air lines, thereby providing a consolidated connection point between the towing vehicle and the trailer. In some embodiments, shock-absorbing elements or articulation joints may be incorporated to improve ride quality, reduce peak load transfer, or provide additional angular degrees of freedom beyond those of a conventional hitch.

The assembly can be manufactured from high-strength steel, aluminum alloys, or other suitable structural materials depending on weight, cost, and strength requirements. Welded gussets and brackets can be configured according to expected load paths and stress concentrations to meet applicable towing standards and safety factors.

While specific embodiments have been described, those skilled in the art will recognize that various modifications, substitutions, and changes may be made without departing from the spirit and scope of the invention as defined by the claims. It is intended that all such modifications and equivalents be included within the scope of the appended claims.

1. A towing clearance extension assembly for use between a towing vehicle and a trailer, comprising:

2. The towing clearance extension assembly of claim 1, wherein the main arm has a length of about 37.56 inches.

3. The towing clearance extension assembly of claim 1, wherein the main arm comprises a rectangular tube having a width of about 3 inches, a height of about 2.5 inches, a first wall thickness of about 0.1945 inches on the width side, and a second wall thickness of about 0.45 inches on the height side.

4. The towing clearance extension assembly of claim 1, wherein the trailer-mounting interface comprises a channel bracket, and wherein the at least one reinforcement gusset comprises at least one gusset plate welded between the main arm and the channel bracket.

5. The towing clearance extension assembly of claim 4, wherein each gusset plate has a thickness of about 0.25 inches and a base dimension of about 4 inches by 4 inches.

6. The towing clearance extension assembly of claim 4, wherein at least one gusset plate extends along a greater portion of a length of the main arm than four inches to increase a reinforced region of the main arm.

7. The towing clearance extension assembly of claim 1, wherein the trailer-mounting interface comprises a multi-position channel bracket configured to receive a lunette ring or other towing accessory at a plurality of vertical positions.

8. The towing clearance extension assembly of claim 7, wherein the channel bracket has a thickness of about 0.2845 inches.

9. The towing clearance extension assembly of claim 1, wherein the towing vehicle comprises a High Mobility Multipurpose Wheeled Vehicle (HMMWV) or HMMWV-based ambulance, and the trailer comprises an M1101 or M1102 military trailer.

10. The towing clearance extension assembly of claim 1, wherein a distance between the trailer-mounting interface and the vehicle-mounting interface is selected such that, when the trailer is coupled to the towing vehicle through the towing clearance extension assembly, a forward region of the trailer remains out of contact with a rear region of the towing vehicle while the trailer is pivoted through sharp turns.

11. The towing clearance extension assembly of claim 10, wherein the distance is sufficient to permit the trailer to be pivoted to at least about ninety degrees relative to a longitudinal axis of the towing vehicle while maintaining clearance between the forward region of the trailer and the rear region of the towing vehicle.

12. The towing clearance extension assembly of claim 11, wherein the clearance provided allows rear doors, tailgates, or ambulance doors of the towing vehicle to be fully opened while the trailer remains attached and pivoted to approximately ninety degrees.

13. The towing clearance extension assembly of claim 7, further comprising a heavy-duty lunette ring coupled to the channel bracket and rated for at least about 7,000 pounds.

14. The towing clearance extension assembly of claim 1, wherein at least one of the main arm length, wall thickness, or gusset placement is varied to adapt the assembly for different towing applications and towing environments.

15. The towing clearance extension assembly of claim 1, wherein the main arm is configured for plug-and-play installation with factory mounting locations of an M1101 or M1102 military trailer.
